(19) United States
(12) Patent Application Publication
(10) Pub. No.: US 2019/0156317 A1
(43) Pub. Date: May 23, 2019

(54) CONTAINER, SHOPPING ASSISTANCE SYSTEM FOR USE WITH SAME, SHOPPING ASSISTANCE METHOD FOR USE WITH SAME

(71) Applicant: Panasonic Intellectual Property Management Co., Ltd., Osaka (JP)

(72) Inventors: Ryusuke KAWAMOTO, Osaka (JP); Tatsuaki AMEMURA, Tokyo (JP)

(21) Appl. No.: 16/194,700

(22) Filed: Nov. 19, 2018

(30) Foreign Application Priority Data
Nov. 20, 2017 (JP) 2017-222946

(51) Int. Cl. G06Q 20/20; B65D 1/38; G06K 9/32

(52) U.S. Cl. CPC G06Q 20/208; G06Q 20/204; G06K 9/3241; B65D 1/38

(57) ABSTRACT

A container is a container which is portable and which includes a body, a receiver, a placement sensor, and a determining processor. The body allows one or more goods to be put in. The placement sensor is provided to the body and is configured to sense that the one or more goods are put in the body. The receiver is provided to the body and is configured to acquire respective one or more pieces of goods information on one or more goods. The determining processor is provided to the body and is configured to determine a placed state of the one or more goods in the body in accordance with an acquisition result by the receiver and a sensed result by the placement sensor.

### CROSS-REFERENCE TO RELATED APPLICATION

The present application is based upon and claims the benefit of priority of Japanese Patent Application No. 2017-222946, filed on Nov. 20, 2017, the entire contents of which are incorporated herein by reference.

### TECHNICAL FIELD

The present disclosure generally relates to containers, shopping assistance systems for use with the containers, and shopping assistance methods for use with the containers. The present disclosure specifically relates to a container for assisting customers in purchasing goods, a shopping assistance system for use with the container, and a shopping assistance method for use with the container.

### BACKGROUND ART

Document 1 (JP H04-58113 U) discloses a goods storage device which is equipped with a computing device and which allows a customer to know, in advance, a sum of money corresponding to goods which the customer is about to purchase. In the goods storage device equipped with a computing device and described in Document 1, the computing device is provided with a barcode reader. The computing device is configured to read barcodes carried by goods with a barcode reader to sum the prices of the goods.

In the case of the goods storage device (container) equipped with a computing device and described in Document 1, a customer may put goods in the goods storage device (body) without the barcodes being read with the barcode reader (receiver). In such a case, a sum of money corresponding to the goods put in the goods storage device does not match a sum of money calculated by the computing device, and a sum of money corresponding to the goods to be purchased by the customer may not correctly checked out.

### SUMMARY

In view of the foregoing, it is an object of the present disclosure to provide a container with which a sum of money corresponding to goods to be purchased by a customer is less likely to be erroneously calculated, a shopping assistance system for use with the container, and a shopping assistance method for use with the container.

A container according to one aspect of the present disclosure is a container which is portable and which includes a body, a receiver, a placement sensor, and a determining processor. The body allows one or more goods to be put in. The placement sensor is provided to the body and is configured to sense that the one or more goods are put in the body. The receiver is provided to the body and is configured to acquire respective one or more pieces of goods information on one or more goods. The determining processor is provided to the body and is configured to determine a placed state of the one or more goods in the body in accordance with an acquisition result by the receiver and a sensed result by the placement sensor.

The shopping assistance system according to one aspect of the present disclosure includes: the container; and a sales system configured to perform a sales process of the one or more goods put in the body.

The shopping assistance method according to one aspect of the present disclosure includes determining a placed state of one or more goods in a body of a container which is portable in accordance with a sensed result of putting of the one or more goods in the body and an acquisition result of respective one or more pieces of goods information on one or more goods. The shopping assistance method includes notifying a user of the container of determination information denoting a determination result or notifying a sales system of the determination information. The sales system is configured to perform a sales process of the one or more goods put in the body.

### BRIEF DESCRIPTION OF DRAWINGS

FIG. 1 is a block diagram illustrating a schematic configuration of a container and a shopping assistance system according to one embodiment of the present disclosure;

FIG. 2 is an exterior perspective view illustrating the container;

FIG. 3 is an exterior perspective view illustrating a counter desk to which the shopping assistance system is applied;

FIG. 4 is a plan view schematically illustrating an arrangement of light-emitting elements and light-receiving elements included in a first sensor in the container;

FIG. 5 is flowchart illustrating an operation of the first sensor of the container;

FIGS. 6A and 6B are timing charts each illustrating an operation of a determining processor of the container when it performs determination of misplacing an item of goods to be put in the container; and

FIG. 7 is a timing chart illustrating an operation of the determining processor of the container when it performs determination of failing to acquire information on an item of goods put in the container.

### DETAILED DESCRIPTION

(1) Schema

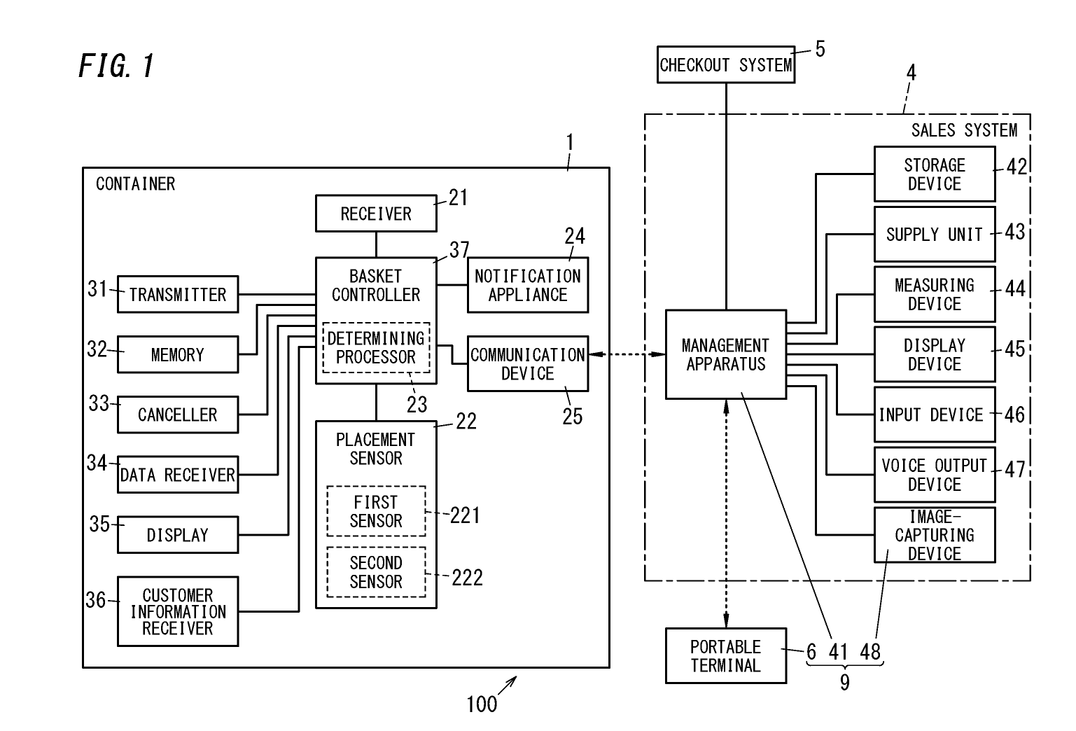

A container 1 according to the present embodiment is portable and is adopted in a shopping assistance system 100 for assisting customers' shopping. In the present embodiment, the container 1 is a shopping basket. The shopping assistance system 100 is introduced to retail stores such as convenience stores, supermarkets, department stores, drugstores, electronics retail stores, and hardware stores. As shown in FIG. 1, the container 1 and a sales system (or a checkout system) 4 constitute the shopping assistance system 100. In other words, the shopping assistance system 100 includes the container 1 and the sales system 4.

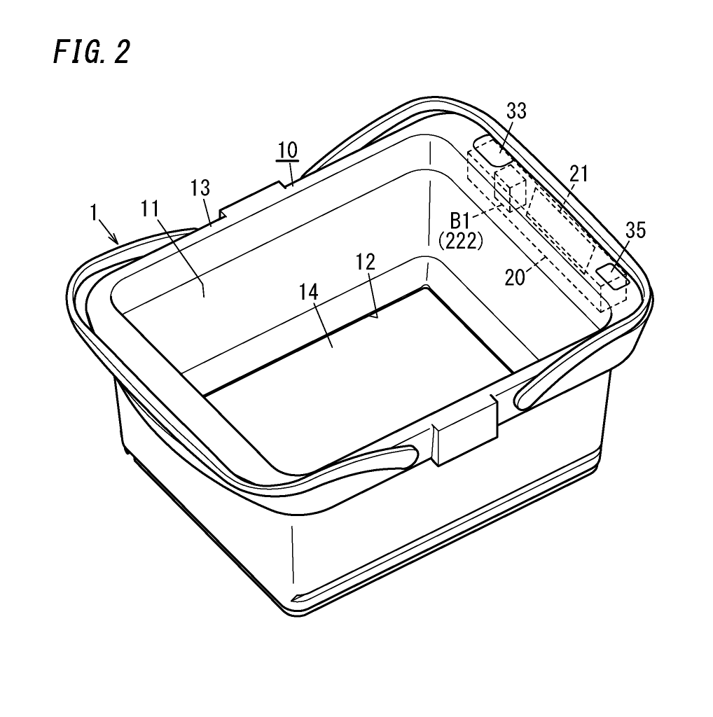

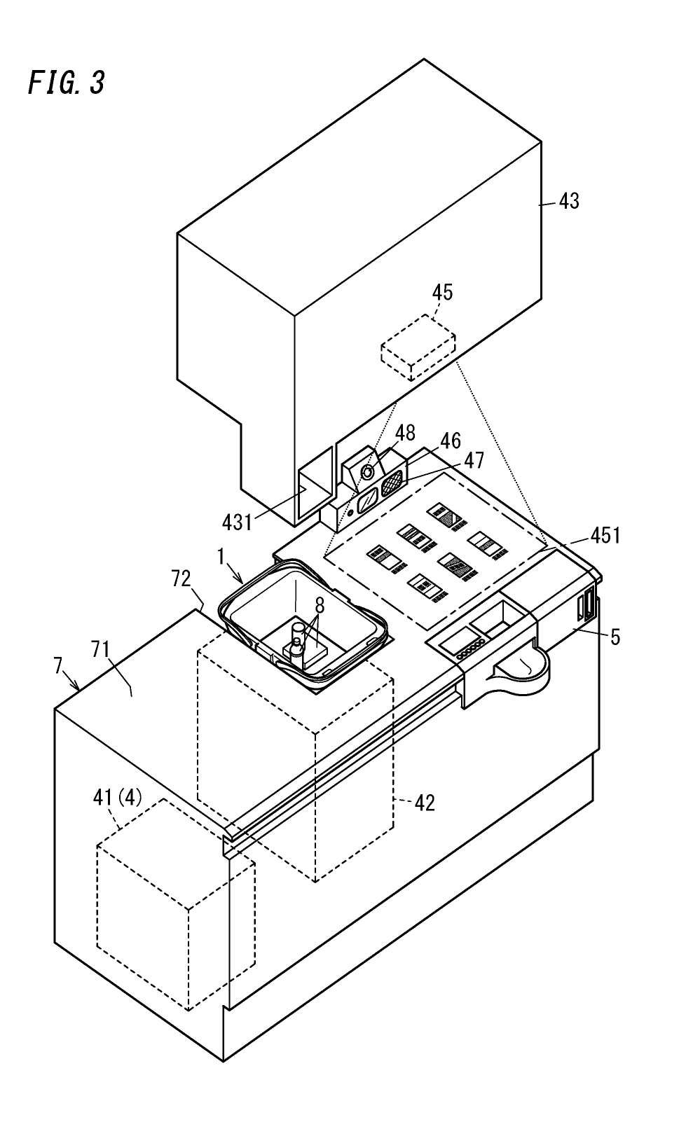

The sales system 4 is configured to directly or indirectly communicate with the container 1. The sales system 4 is a system configured to perform a sales process (or a checkout process) of goods 8 (see FIG. 3) put in a body 10 (see FIG. 2). As used herein, a “sales process” refers to various processes required for actions (sales and purchase) of transferring the ownership of goods from a seller (store) to a buyer (customer) and paying the seller the consideration (charge) for the goods by the buyer. The sales process includes, for example, an acquisition process, an order process, and the like. The acquisition process is a process of acquiring respective one or more pieces of goods information on one or more goods 8 picked up by a customer in a store. The order process is a process of receiving, from a customer, an order for one or more goods 8 which the customer wishes to buy.

As shown in FIG. 1, the container 1 includes the body 10, a receiver 21, a placement sensor 22, and a determining processor 23. The body 10 allows goods 8 to be put in. It is only required that the body 10 is configured to allow one or more goods 8 to be put in.

The receiver 21 is provided to the body 10 and is configured to acquire goods information on goods 8. In the present disclosure “goods information” is information for identifying each of goods 8 (information identification code), and examples thereof in Japan include Japanese Article Number (JAN) code and the like. Examples of the goods identification code include European Article Number (EAN) code in Europe, Universal Product Code (UPC) in USA and the like in addition to the JAN code.

The placement sensor 22 is provided to the body 10 and is configured to sense that goods 8 are put in the body 10. That is, the placement sensor 22 senses that an item of goods 8 picked up to be purchased by a customer is put in the body 10.

The determining processor 23 is provided to the body 10 and is configured to determine a placed state of goods 8 in the body 10 (hereinafter also simply referred to as a “placed state”) in accordance with an acquisition result by the receiver 21 and a sensed result by the placement sensor 22. For example, the determining processor 23 determines, as the placed state, whether or not information acquired goods are in the body 10 by the placement sensor 22. The term “information acquired goods” is hereinafter used to refer to at least an item of goods 8 (in the embodiment, an item of goods 8, or a product), whose goods information has been acquired by the receiver 21. Moreover, for example, the determining processor 23 determines, as the placed state, whether or not placed-goods information has been acquired by the receiver 21. The term “placed-goods information” is hereinafter used to refer to information on placed-goods 8 having been sensed by the placement sensor 22. Here, the placed-goods 8 are at least an item of goods (in the embodiment, an item of goods 8, or a product).

As described above, in the present embodiment, it is possible to determine whether or not a customer forgets to make the receiver 21 acquire respective goods information and/or whether or not a customer forgets to put, in the body 10, one or more goods 8 on which respective one or more pieces of goods information the customer have made the receiver 21 acquire. Thus, the present embodiment provides the advantage that a user corrects the placed state of goods 8 in the body 10 based on the determination result to reduce the occurrence of wrong checkout of the goods 8 to be purchased by a customer.

(2) Details

The container 1 according to the present embodiment and the shopping assistance system 100 for use with the container 1 will be described in detail below. In the present embodiment, a convenience store is exemplified as a store which the container 1 and the shopping assistance system 100 are introduced into. That is, a “user” in the present disclosure is a customer in the convenience store and/or an employee (clerk) in the convenience store.

(2.1) Shopping Assistance System

Herein, the overall structure of the shopping assistance system 100 according to the present embodiment will first be explained. As shown in FIG. 1, the shopping assistance system 100 includes the container 1, a checkout system 5, and the sales system 4. Note that the checkout system 5 does not have to be a component included in the shopping assistance system 100.

The sales system 4 includes a management apparatus 41, a storage device 42, a supply unit 43, a measuring device 44, a display device 45, an input device 46, a voice output device 47, and an image-capturing device 48. Each of the storage device 42, the supply unit 43, the display device 45, the measuring device 44, the input device 46, the voice output device 47, and the image-capturing device 48 is a peripheral device of the management apparatus 41 and is connected to the management apparatus 41.

The management apparatus 41 is configured to receive goods information and determination information (which will be described later) transmitted from the container 1. Moreover, the management apparatus 41 is connected to the checkout system 5 which performs a checkout process. Moreover, the management apparatus 41 is configured to communicate with a store terminal composed of, for example, a point of sale (POS) terminal. The management apparatus 41 is configured to perform a predetermined process such as a transmission process of transmitting information required for the checkout process performed by the checkout system 5 to the checkout system 5 based on the goods information received from the container 1. Moreover, the management apparatus 41 is configured to communicate also with the portable terminal 6 and the storage device 42 to control the portable terminal 6 and the storage device 42.

The checkout system 5 includes a computer system as a main component and peripheral devices such as a cash unit configured to accept and dispense cash. The checkout system 5 is configured to cause a processor of the computer system to execute a program stored in a memory of the computer system, thereby performing the checkout process such as calculation of a checkout amount based on the goods information received from the sales system 4. The checkout system 5 includes a card reader and a printer configured to issue a receipt. The card reader is configured to read, for example, credit card information and electronic money card information for payment, mobile phone terminal information, member's card information, and loyalty card information. Information such as for example, detailed statement, checkout amount, purchase date and time is described in the receipt.

In the present embodiment, the checkout system 5 stores price data corresponding to each goods information. In addition, the checkout system 5, the store server, or the center server may store: an information set such as advertisement information, discount information, producer information and recipe information, corresponding to each goods information; and information such as gender, age, favorite and past purchase history, corresponding to each customer information. The information set, which is not stored in the sales system 4, is available to the sales system 4 as a result of the sales system 4 communicating with the checkout system 5, the store server, or the center server.

The storage device 42 is a device configured to transfer an item of goods 8 (a product) put in the container 1 placed at a predetermined location (in the present embodiment, on a bottom surface of a recess 72 of a counter desk 7 which will be described later) from the container 1 to another container, thereby storing (putting) the item of goods 8 in the another container. When goods 8 (products) are put in the container 1, the storage device 42 is also able to collectively transfer the goods 8 to another container. In the present embodiment, a bag made of polyethylene as what is called a shopping bag (or a plastic shopping bag) is exemplified as the another container. Since the another container is the bag, the “storing” to be performed by the storage device 42 means “bagging”. Note that the storage device 42 is not limited to the configuration to use bags as long as it is configured to store one or more goods 8 in another container. For example, the storage device 42 may be configured to store one or more goods 8 into another container such as a reusable shopping bag, a takeout container, or a case.

The supply unit 43 is configured to supply customers with one or more specific goods (e.g., cigarettes). The display device 45 is a device configured to display various kinds of information to customers. The measuring device 44 is a device configured to weigh the container 1 with goods 8 put in the body 10. The input device 46 is a device configured to receive an operation performed by a customer through, for example, gesture detection. Moreover, the input device 46 includes a microphone and has a function of applying speech recognition and semantic analysis to a voice signal output from the microphone. Thus, a voice operation (voice input) by a customer is also possible. The voice output device 47 includes a loudspeaker and is configured to provide customers with various kinds of information by the voice.

That is, the sales system 4 uses the display device 45, the input device 46, and the voice output device 47 as user interfaces to provide customers with various kinds of information by the display or the voice and to receive operations (including voice input) by the customers. Note that provision of the information by the sales system 4 may be realized by at least one of the display and the voice. That is, the provision of the information may be realized by any one of the display and the voice, or realized by a combination of the display and the voice.

As an example, the sales system 4 may provide customers with messages such as “Welcome” and “Thank you very much” when the arrival of the customers is sensed and when the checkout process is completed. It is accordingly possible to give customers a sense of affinity like clerk service. For example, customers are to operate the input device 46 to select one of payment methods to pay the checkout amount displayed on the display device 45. The sales system 4 may also provide customers with a utilization procedure for the shopping assistance system 100 by the display device 45 and the voice output device 47. In this case, for example, when the container 1 is placed at a predetermined location, the display device 45 and the voice output device 47 then explain each step of the utilization procedure sequentially, thereby confirming whether or not the fast food or the cigarettes are purchased, etc.

Moreover, the image-capturing device 48 is a camera configured to photograph customers. The image-capturing device 48, together with the management apparatus 41 and the portable terminal 6, forms an age verification system 9. In other words, the age verification system 9 includes the management apparatus 41, the image-capturing device 48, and the portable terminal 6. The age verification system 9 is a system which assists a clerk (checker) in checking the age of a customer (subject).

The portable terminal 6 is a terminal carried by a clerk. The portable terminal 6 is configured to wirelessly perform two-way communication with the management apparatus 41 by a radio wave as a medium. The management apparatus 41 transmits a request signal to the portable terminal 6. The request signal includes image data of an image obtained by imaging a subject (customer) as a target of the age verification. The portable terminal 6 receives the request signal, and based on the image data included in the request signal, the portable terminal 6 displays on-screen age verification including the image obtained by imaging the subject. In this state, a checker (clerk) watches the on-screen age verification displayed on the portable terminal 6 to perform age verification of the subject. When receiving a result of the age verification performed by the checker as an operation by the checker, the portable terminal 6 transmits a response signal including the result of the age verification to the management apparatus 41.

Here, as shown in FIG. 3, the shopping assistance system 100 is disposed, for example, around a counter desk 7 installed at a checkout counter in a store. That is, around the counter desk 7, the shopping assistance system 100 is disposed. One store may be provided with a plurality of counter desks 7.

The counter desk 7 is formed with a recess 72 that opens in a substantially central portion of the upper surface 71 in a lengthwise direction (lateral direction). The recess 72 serves as a space that allows the body 10 of the container 1 to be put in. The recess 72 opens backward as viewed from the front side of the counter desk 7. The storage device 42 and the measuring device 44 are installed under the recess 72.

The supply unit 43 is suspended from a ceiling to be provided above the counter desk 7. The management apparatus 41 is built in the counter desk 7. The checkout system 5 is disposed on the right side of the storage device 42 as viewed from the front side of the counter desk 7. The display device 45 is fixed to a lower surface of the supply unit 43 and is configured to project an image onto a screen 451 by, for example, a projection mapping technique. Herein, the display device 45 projects an image onto a right region with respect to the storage device 42 in the upper surface 71 of the counter desk 7 as viewed from the front side of the counter desk 7. That is, the right region with respect to the storage device 42 in the upper surface 71 of the counter desk 7 serves as the screen 451 of the display device 45. The input device 46 is on the upper surface 71 of the counter desk 7 and is disposed behind the screen 451 as viewed from the front side of the counter desk 7. The input device 46 is provided integrally with the voice output device 47.

Stores which the shopping assistance system 100 is introduced into enable customers to finish purchasing goods 8 by a series of processes of choosing the goods 8 in the stores, putting them in the container 1, performing the checkout process thereof, and receiving the goods 8 automatically stored in another container. Thus, with the shopping assistance system 100, it is possible to reduce, for example, a time from the start of the checkout process to the customer getting the goods 8 while saving clerk's labor and customers' labor, thereby reducing customers' shopping time.

(2.2) Container

Next, the container 1 according to the present embodiment will be explained in detail. As shown in FIG. 2, the container 1 includes the body 10 and a circuit block 20. The body 10 is in a shape of a box that has at least an opening at the top, and the body 10 allows one or more goods 8 to be put in. The circuit block 20 accommodates a battery and various circuits and modules each of which is configured to receive electric power from the battery to be activated. The circuit block 20 is built in part of the body 10. Note that for a display 35 included in the circuit block 20, the body 10 exposes, from an inner side surface thereof, at least a screen of the display 35. In addition, the body 10 exposes, from an outer side surface, part of the circuit block 20 such as the receiver 21 and a canceller 33 to be described later.

As shown in FIG. 2, the body 10 includes a side part 13 and a bottom panel (bottom part) 14. The side part 13 may be but is not limited to be composed of four sides. Each of the side part 13 and the bottom panel 14 is made of, for example, a synthetic resin.

The side part 13 is formed with an upper opening 11 and a lower opening 12 and allows one or more goods 8 to be put in. The bottom panel 14 is attached to the side part 13 to allow opening and closing of the lower opening 12. Here, the lower opening 12 has a shape and dimensions that allow the one or more goods 8 to pass through the lower opening 12. The bottom panel 14 closing the lower opening 12 enables the one or more goods 8 to be put in an internal space surrounded by the side part 13 and the bottom panel 14. On the other hand, the bottom panel 14 opening the lower opening 12 enables the one or more goods 8 to exit from the internal space through the lower opening 12.

That is, the side part 13 is formed with openings in both of an upper surface and a lower surface thereof (upper opening 11 and lower opening 12). The body 10 is configured such that the bottom panel 14 moves relative to the side part 13, and thereby, the lower opening 12 is opened and closed. That is, when the bottom panel 14 is in a closing position, the bottom panel 14 closes the lower opening 12. On the other hand, when the bottom panel 14 moves from the closing position to an opening position, the bottom panel 14 then opens the lower opening 12.

With this configuration, the bottom panel 14 moves from the closing position to the opening position with the one or more goods 8 put in the body 10, thereby enabling the one or more goods 8 to exit through the lower opening 12. That is, when the bottom panel 14 moves with the body 10 put at the predetermined location (in the present embodiment, on a bottom surface of the recess 72 of the counter desk 7), the one or more goods 8 in the body 10 exit through the lower opening 12. The one or more goods 8 which have exited through the lower opening 12 are stored (bagged) in another container by the storage device 42.

After the one or more goods 8 put in the body 10 exit from the body 10, the container 1 is collected from the counter desk 7. The container 1 collected is moved to a basket area, for example, near an entrance of the store. A plurality of containers 1 are placed in the basket area.

As shown in FIG. 1, the circuit block 20 includes the receiver 21, the placement sensor 22, a transmitter 31, a memory 32, the canceller 33, a data receiver 34, the display 35, a customer information receiver 36, a basket controller 37, a notification appliance 24, and a communication device 25. Moreover, the basket controller 37 includes the determining processor 23.

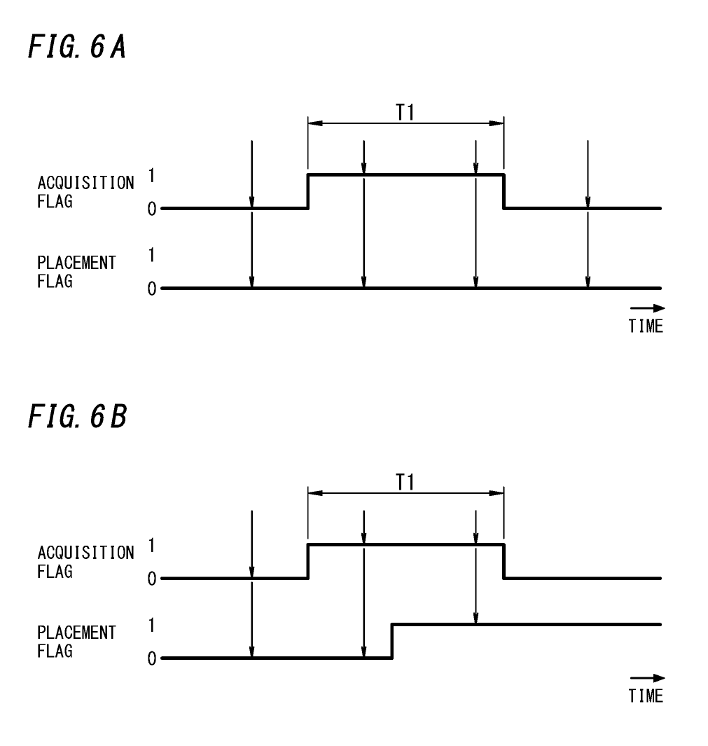

The receiver 21 is configured to read respective goods information from goods 8 to be put in the body 10 to acquire the respective goods information on the goods 8. The receiver 21 is exposed from the outer side surface of the body 10. The receiver 21 is a barcode reader and optically reads a barcode that each of the goods 8 carries to acquire goods information thereon. Therefore, a customer picks up each of the goods 8 to show it to the receiver 21 and then puts it in the body 10. In this case, it can be said that the goods information on each of the goods 8 put in the body 10 has been acquired by the receiver 21. At this time, the receiver 21 sets an acquisition flag for a constant time T1 (see FIG. 6A) since acquisition of the goods information is completed. The receiver 21 is not limited to the barcode reader, but examples thereof may further include a reader configured to read a two-dimensional code and a tag reader configured to read goods information from a radio-frequency identification (RFID) tag in a contactless manner.

The receiver 21 may also be configured to read goods information from, for example, each image of the goods 8. In this example, the receiver 21 includes an image sensor configured to photograph the goods 8 inside or outside the body 10. The receiver 21 may specify respective goods information of the goods 8 by performing image recognition processing with respect to each of the goods 8, extracting feature such as outline, color and texture information therefrom, and verifying by comparing the feature with a template stored for each of goods 8 in advance. In this example, the receiver 21 may utilize information read with the barcode reader as auxiliary information for reading goods information from each image of the goods 8. Alternatively, the barcode reader may be omitted when it is possible to sufficiently read goods information from only each image of goods 8.

The placement sensor 22 is provided to the body 10 and is configured to sense that the goods 8 are put in the body 10. The placement sensor 22 includes a first sensor 221 and a second sensor 222.

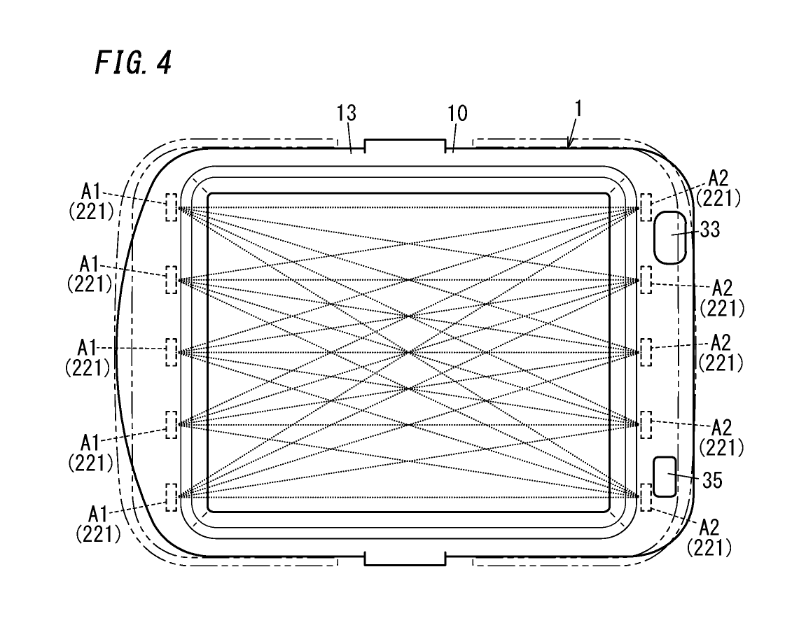

The first sensor 221 is a transmission-type optical sensor (photo-interrupter) and includes, as shown in FIG. 4, a plurality of (in this embodiment, five) light-emitting elements A1 and a plurality of (in this embodiment, five) light-receiving elements A2. Each light-emitting element A1 is, for example, a light-emitting diode. Each light-receiving element A2 is, for example, a phototransistor. The plurality of light-emitting elements A1 and the plurality of light-receiving elements A2 are provided to the body 10 such that a set of the plurality of light-emitting elements A1 and a set of the plurality of light-receiving elements A2 face each other with a specific area (in this embodiment, upper opening 11) therebetween. The specific area corresponds to an opening through which the goods 8 are put in the body 10. Thus, each of the plurality of light-receiving elements A2 receives light emitted from the plurality of light-emitting elements A1 and passing through the specific area. Dotted lines shown in FIG. 4 represent light rays from the light-emitting elements A1 and travelling toward the light-receiving elements A2 in a simulated manner.

When the quantity of light received by one or more light-receiving elements A2 of the plurality of light-receiving elements A2 changes, the first sensor 221 senses that an item of goods 8 passes through the specific area. That is, when the item of goods 8 passes through the specific area, the item of goods 8 interrupts light emitted from one or more light-emitting elements A1, thereby changing the quantity of light received by the one or more light-receiving elements A2. Thus, when the quantity of light received by the one or more light-receiving elements A2 changes, the first sensor 221 senses that the item of goods 8 passes through the specific area.

The second sensor 222 is an acceleration sensor B1 including a semiconductor and is provided at a location in the body 10 where the acceleration of the body 10 is sensible to the second sensor 222. The second sensor 222 senses the acceleration of vibration of the body 10 that is caused by an impact at the bottom panel (bottom part) 14 when the item of goods 8 is put in the body 10. Thus, when the acceleration larger than or equal to a prescribed value occurs, the second sensor 222 senses that the item of goods 8 reaches the bottom panel (bottom part) 14 of the body 10. The prescribed value is, for example, preferably smaller than the acceleration that occurs due to swinging of the body 10 while a customer carrying the container 1 moves.

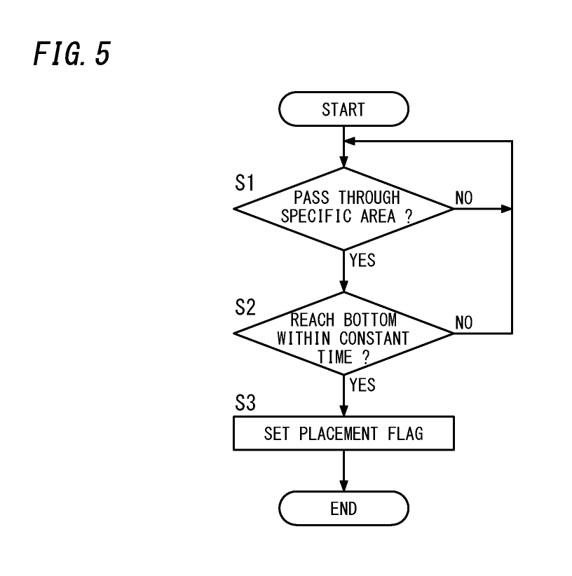

In the present embodiment, the placement sensor 22 senses that an item of goods 8 is put in the body 10 based on a sensed result by the first sensor 221 and a sensed result by the second sensor 222. As shown in FIG. 5, specifically, the placement sensor 22 first monitors the sensed result by the first sensor 221 (S1). If the first sensor 221 senses that an item of goods 8 passes the specific area (S1: Yes), the placement sensor 22 monitors the sensed result by the second sensor 222 for a constant time from a time point of sensing by the first sensor 221 (S2). If within the constant time, the second sensor 222 senses that the item of goods 8 reaches the bottom panel (bottom part) 14 of the body 10 (S2: Yes), the placement sensor 22 determines that the item of goods 8 is put in the body 10, and the placement sensor 22 sets a placement flag (S3).

On the other hand, if the first sensor 221 does not sense that the item of goods 8 passes the specific area (S1: No), the placement sensor 22 determines that the item of goods 8 is not put in the body 10. If the second sensor 222 does not sense that the item of goods 8 reaches the bottom panel (bottom part) 14 of the body 10 within the constant time from the time point of sensing by the first sensor 221 (S2: No), the placement sensor 22 determines that the item of goods 8 is not put in the body 10. In these cases, the placement sensor 22 does not set the placement flag.

The transmitter 31 is configured to transmit goods information acquired through the receiver 21 to the sales system 4. In the present embodiment, the transmitter 31 is composed of a communication module configured to perform two-way communication with the sales system 4. The transmitter 31 communicates with the sales system 4 by optical wireless communication whose medium is radiation such as infrared radiation or visible radiation. Among different types of wireless communication, especially, near field type communication (near field wireless communication) having a narrow communication area is applicable because the transmitter 31 transmits goods information with the body 10 placed on the counter desk 7.

The memory 32 is configured to store one or more pieces of goods information. For example, whenever the receiver 21 reads goods information, the goods information is stored in the memory 32. The transmitter 31 may transmit the one or more pieces of goods information stored in the memory 32 all together to the sales system 4 or divide the one or more pieces of goods information into packets to transmit the packets to the sales system 4. In the present embodiment, the memory 32 stores goods information acquired through the receiver 21 and the number thereof (i.e., acquisition count of goods information by the receiver 21). For example, when there is one or more pieces of goods information as respective goods information on three goods 8 that include two goods 8 of “A” and one item of goods 8 (or one product) of “B”, the memory 32 stores goods information on “A”, “2” as count thereof, goods information “B”, and “1” as count thereof. For example, when the transmitter 31 succeeds in transmitting the one or more pieces of goods information to the sales system 4, the one or more pieces of goods information stored in the memory 32 is deleted.

The canceller 33 is configured to receive a cancel operation for deleting at least one piece of goods information from the one or more pieces of goods information stored in the memory 32. For example, even if goods information is read through the receiver 21 and is then stored in the memory 32, the canceller 33 receives a cancel operation thereof, thereby enabling the deletion thereof from the memory 32. Specifically, the canceller 33 includes a cancel button that is disposed at an operable location by customers such as an outer side surface of the body 10. The cancel operation is an operation for causing the receiver 21 to read goods information to be deleted during a constant time starting when the cancel button is pushed (e.g., five seconds), or while the cancel button is being pushed. Customers performing the cancel operation enable deletion of one or more pieces of goods information selected by the cancel operation from the memory 32.

The data receiver 34 is configured to receive display data transmitted from the sales system 4. The display data is data to be presented by the display 35, such as an advertisement or recommendation information suitable for customers. In the present embodiment, the data receiver 34 is composed of a communication module configured to perform two-way communication with the sales system 4. The data receiver 34 is configured to perform communication with the transmitter 31 by wireless communication whose medium is radio such as, for example, Wi-Fi (trademark) or Bluetooth (trademark).

The display 35 is configured to perform display based on the display data received by the data receiver 34. The display 35 includes, for example, a liquid crystal display (LCD). The display 35 functions as a browser configured to display a picture according to the display data as contents delivered (transmitted) from the sales system 4. Note that the display 35 may have a function as a user interface that allows customers to enter an operation into, in addition to display of various information like, for example, a touch panel display.

The customer information receiver 36 is configured to acquire customer information of a customer who is to put one or more goods 8 in the body 10. The customer information receiver 36 is composed of, for example, a card reader configured to read customer information from various cards such as member's cards, loyalty cards, and credit cards. The customer information receiver 36 may be, for example, a contactless card reader. Herein, the “customer information” is information on an individual customer, and it is only required that the customer information includes at least customer identification information (customer ID) for confirming the identity of the individual customer. The customer information receiver 36 is not limited to the card reader, but may acquire customer information by communication with a personal digital assistant (smartphone or the like) that the customers carry, or by biometrics authentication (including facial recognition). The transmitter 31 may transmit, to the sales system 4, the customer information acquired through the customer information receiver 36 along with the pieces of goods information.

The basket controller 37 including the determining processor 23 and the like includes a microcontroller as a main component and is configured to cause a processor of the microcontroller to execute a program stored in a memory of the microcontroller, thereby controlling each part of the circuit block 20 such as the receiver 21. The program may be stored in the memory in advance, provided via a telecommunications network such as the Internet, or provided via a storage medium such as a memory card storing the program.

The determining processor 23 corresponds to a function of the basket controller 37 and is configured to determine the placed state of the goods 8 in the body 10 in accordance with an acquisition result by the receiver 21 and a sensed result by the placement sensor 22. In the present embodiment, the determining processor 23 regularly monitors the acquisition result by the receiver 21 and the sensed result by the placement sensor 22 to determine the placed state. In the present disclosure, “acquisition result” includes a result that respective one or more pieces of goods information of one or more goods 8 are received by the receiver 21 or a result that the respective one or more pieces of goods information are not received. Moreover, in the present disclosure, “sensed result” includes a result that putting one or more goods 8 in the body 10 is sensed by the placement sensor 22 or a result that the putting is not sensed. A determination operation by the determining processor 23 will be described later in detail in “(3.2) Determination of Placed state of Goods in Container”.

The notification appliance 24 is provided to the body 10 and is configured to inform a user (in this embodiment, customer) of determination information denoting the determination result by the determining processor 23. In the present disclosure, “determination information” is information denoting that information acquired goods have not been put in the body 10 or information denoting that placed-goods information has not been acquired by the receiver 21. In the present embodiment, the notification appliance 24 is a loudspeaker built in the body 10. The notification appliance 24 causes a loudspeaker to rumble and to reproduce a voice according to the determination information, thereby notifying a user of the determination information.

The notification appliance 24 may be a light-emitting element built in the body 10. In this case, the notification appliance 24 emits light in a specific color (e.g., red) according to the determination information or causes the light-emitting element to blink in a prescribed pattern according to the determination information, thereby notifying a user of the determination information. Alternatively, the notification appliance 24 may be configured to inform a user of the determination information by combining the notifying by the voice described above and the notifying by the light emission.

The communication device 25 is provided to the body 10 and is configured to notify the sales system 4 (in this embodiment, management apparatus 41) of determination information denoting the determination result by the determining processor 23. In the present embodiment, the communication device 25 is composed of a communication module configured to perform one-way communication with the sales system 4. The communication device 25 will perform communication with the sales system 4 by wireless communication whose medium is radio such as, for example, Wi-Fi (trademark) or Bluetooth (trademark). The communication device 25 transmits a signal including the determination information to the sales system 4 by the wireless communication, thereby notifying the sales system 4 of the determination information.

(3) Operation

An operation of the shopping assistance system 100 according to the present embodiment will be explained below.

(3.1) Basic Operation

A basic operation of the shopping assistance system 100 from a customer's visit to a store until completion of putting in of the goods 8 will be explained.

A customer visiting a store takes the container 1 from a basket area. The customer carrying the container 1 subsequently moves in the store and puts goods 8 that the customer desires to purchase one by one in the body 10 of the container 1. At this moment, the customer shows the goods 8 picked up to the receiver 21 and then puts the goods 8 in the body 10. Thus, the receiver 21 acquires respective goods information on the goods 8.

The customer subsequently puts, at the predetermined location (on a bottom of the recess 72 in the counter desk 7), the container 1 that all the goods 8 that the customer desires to purchase are put in. At this moment, a sensor installed, for example, in the bottom of the recess 72 in the counter desk 7 senses that the container 1 is placed on the predetermined location. The sales system 4 receives a sensed result by the sensor and then starts communication with the container 1, thereby acquiring the goods information from the container 1.

When acquiring the goods information, the sales system 4 transmits (transfers) the goods information to the checkout system 5. The sales system 4 acquires price data transmitted as a reply (response) to the goods information from the checkout system 5. Moreover, the sales system 4 creates a purchase list containing pieces of information on the goods 8 based on the price data thus acquired.

At this moment, when notified of the determination information from the container 1 in advance, the sales system 4 executes a weight determining process for checking whether or not the goods 8 put in the body 10 match targets of the checkout process based on weight. In the present embodiment, the weight determining process is performed, for example, when the purchase list is created, but the weight determining process may be performed at any timing as long as it is performed before the checkout process is executed.

The sales system 4 calculates the total weight of the goods put in the body 10 based on the weight data of the goods 8 acquired from the checkout system 5 as a reply to the pieces of goods information. Then, the sales system 4 compares the total weight of the goods 8 thus calculated with weight measured by the measuring device 44.

In this case, when the total weight is out of a prescribed range, the sales system 4 does not proceeds to an age verification process by the age verification system 9 described next but transmits a notification to, for example, the portable terminal 6 which a clerk carries. On the other hand, when the total weight is in the prescribed range, the sales system 4 proceeds to the age verification process. In the present disclosure, “prescribed range” is a numerical range based on the measured value by the measuring device 44 and, for example, includes a predetermined margin centered on a value obtained by subtracting the weight of the container 1 from the measured value of the measuring device 44. The predetermined margin is, for example, several percent of the total weight, preferably 1% of the total weight.

Employing the weight determining process enables the sales system 4 to judge whether or not the goods 8 actually put in the body 10 match the targets of the checkout process. This reduces cases where the checkout system 5 performs the checkout process based on respective goods information on wrong goods 8, for example, when a customer forgets to make the receiver 21 acquire the respective goods information.

Moreover, at this time, the sales system 4 judges whether or not the purchase list includes specific goods which require age verification. As an example of the specific goods, the present embodiment includes alcohol (alcohol goods). Herein, the sales system 4 judges whether or not alcohol is included in the goods 8 put in the container 1 based on the purchase list. When alcohol is contained in the purchase list, the sales system 4 transmits a start signal to the age verification system 9. The age verification system 9 receives the start signal and then starts a series of processes for the age verification.

When the age verification system 9 succeeds in the age verification, or when the purchase list includes no alcohol, the sales system 4 causes the display device 45 to display an on-screen confirmation for cigarettes. With the on-screen confirmation for cigarettes, it is confirmed whether or not cigarettes which are the specific goods are to be purchased. When “purchasing the cigarettes” is selected in the on-screen confirmation for cigarettes, the sales system 4 transmits the start signal to the age verification system 9. When the age verification system 9 succeeds in the age verification, the sales system 4 causes the display device 45 to display an on-screen cigarette menu that allows customers to select one of cigarette brands. Note that when the purchase list includes alcohol and the age verification has already been successfully performed, the sales system 4 may cause the display device 45 to display the on-screen cigarette menu directly after “purchase cigarettes” is selected on the on-screen confirmation for cigarettes.

In the on-screen cigarette menu, when one or more specific cigarette brands are selected, the sales system 4 transmits the respective one or more pieces of goods information of the one or more specific cigarette brands to the supply unit 43. The supply unit 43 selects corresponding one or more cigarette packs from cigarette packs stocked in the supply unit 43 and dispenses the one or more cigarette packs (i.e., cigarettes) thus selected to an outlet 431 (see FIG. 3). This configuration enables customers to receive the cigarettes dispensed through the outlet 431. Moreover, the sales system 4 acquires price data of the cigarettes from the checkout system 5 and adds the price data to the purchase list.

When supply of the cigarettes from the supply unit 43 is completed or “do not purchase cigarettes” is selected in the on-screen confirmation for cigarettes, the sales system 4 proceeds to the checkout process. At this time, the sales system 4 causes the display device 45 to display an on-screen checkout confirmation including the purchase list. When start checkout is selected in the on-screen checkout confirmation, the sales system 4 causes the checkout system 5 to start the checkout process.

Moreover, when the age verification system 9 fails the age verification, the sales system 4 stops the sales process of the specific goods (in this embodiment, alcohol and cigarettes). When the age verification in a sales process of cigarettes fails, the sales system 4 stops the sales process of the cigarettes and proceeds to the checkout process. When the age verification in a sales process of alcohol fails, the sales system 4 does not display the on-screen confirmation for cigarettes and stops the alcohol sales process.

After the checkout process is started, the sales system 4 causes the storage device 42 to perform storing of the goods 8. That is, after causing the checkout system 5 to start the checkout process, the sales system 4 transmits a control signal for starting a storing process to the storage device 42. The storage device 42 accordingly transfers the goods 8 from the container 1 to another container while the checkout process of the goods 8 is performed. Note that preferably after the checkout process is completed, the customer is allowed to receive the another container storing the goods 8 with the storing process by the storage device 42 being completed.

(3.2) Determination of Placed State of Goods in Container

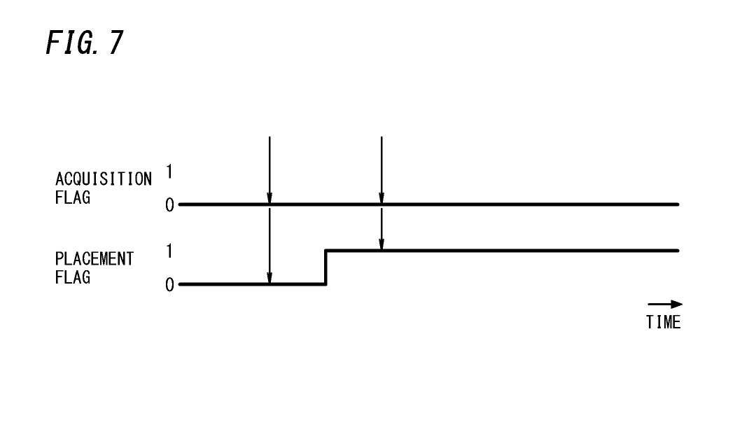

Next, a determination operation of the placed state of the goods 8 in the container 1 will be described with reference to FIGS. 6A to 7. The determining processor 23 is configured to monitor an acquisition flag by the receiver 21 and a placement flag by the placement sensor 22 regularly (e.g., every several milliseconds). The downward arrows in FIGS. 6A and 7 indicate timings at which the determining processor 23 monitors the acquisition flag and the placement flag. Moreover, in FIGS. 6A to 7, for both the acquisition flag and the placement flag, “1” represents that a flag is set, and “0” represents that a flag is not set.

In this embodiment, when the receiver 21 completes acquiring the goods information, the receiver 21 sets an acquisition flag for a constant time T1. As illustrated in FIG. 6A, when the placement flag is not set within the constant time T1 after the setting of the acquisition flag is confirmed, the determining processor 23 determines that information acquired goods has not been put in the body 10, that is, the occurrence of missing placement. The term “missing placement” is hereinafter used to refer to an event that a customer forgets to put information acquired goods in the body 10.

In this case, the notification appliance 24 notifies determination information denoting a determination result (in this embodiment, the missing placement) by the determining processor 23. For example, the notification appliance 24 causes a loudspeaker built in the body 10 to rumble and to reproduce a voice saying that “goods on which pieces of goods information have been acquired are not put in”. Moreover, for example, the notification appliance 24 causes a light-emitting element built in the body 10 to emit light in a specific color or in a specific pattern. Thus, the notification appliance 24 notifies the customer (user) having the container 1 that the missing placement occurs.

On the other hand, as illustrated in FIG. 6B, when a placement flag is set within a constant time T1, the determining processor 23 determines that the information acquired goods are successfully put in. In this case, the notification appliance 24 performs nothing. That is, the determining processor 23 determines, as a placed state of the goods 8 in the body 10, whether or not the placement sensor 22 senses that the information acquired goods are put in the body 10. Specifically, the determining processor 23 determines whether or not information acquired goods are put in the body 10 based on a sensed result by the placement sensor 22 within a constant time T1 from a time point at which the receiver 21 acquires goods information.

Moreover, as illustrated in FIG. 7, when a placement flag is set without an acquisition flag being set, the determining processor 23 determines that placed-goods information has not been acquired by the receiver 21, that is, the occurrence of missing acquisition. The term “missing acquisition” is hereinafter used to refer to an event that a user forgets to make the receiver 21 acquire goods information. In this case, the notification appliance 24 notifies determination information denoting a determination result (in this example, missing acquisition) by the determining processor 23. For example, the notification appliance 24 causes the loudspeaker built in the body 10 to rumble, thereby reproducing a voice such as “goods on which pieces of goods information have not been acquired are put in”. Moreover, for example, the notification appliance 24 causes a light-emitting element built in the body 10 to emit light in a specific color different from a color in the case of the missing placement, or in a specific pattern different from a pattern in the case of the missing placement. Thus, the notification appliance 24 notifies a customer (user) carrying the container 1 of the occurrence of missing acquisition. That is, the determining processor 23 determines, as a placed state of the goods 8 in the body 10, whether or not the placed-goods information is acquired by the receiver 21.

When the determining processor 23 determines the occurrence of the missing placement or the occurrence of the missing acquisition, the communication device 25 notifies the sales system 4 of the determination information. When notified of the determination information, as described above, the sales system 4 executes a weight determining process before proceeding to the age verification process by using the age verification system 9. On the other hand, when not notified of the determination information, the sales system 4 proceeds to the age verification process without performing the weight determining process.

(4) Variation

The above-described embodiment is a mere example of various embodiments of the present disclosure. Various modifications are possible depending on design and the like as long as the above-described embodiment can achieve the object of the present disclosure. Moreover, functions similar to those of the shopping assistance system 100 may be realized by a shopping assistance method, a computer program, a non-transitory storage medium storing a computer program, or the like. A shopping assistance method according to one aspect includes determining a placed state of one or more goods 8 in a body 10 of a container 1 which is portable in accordance with a sensed result of putting of the one or more goods 8 in the body 10 and an acquisition result of respective one or more pieces of goods information on one or more goods 8. The shopping assistance method further includes notifying a user of the container 1 of determination information denoting a determination result or notifying a sales system 4 of the determination information. The sales system 4 is configured to perform a sales process of the one or more goods 8 put in the body 10. Variations of the above-described embodiment will be described below. The variations described below may be combined as appropriate.

The shopping assistance system 100 in the present disclosure includes a computer system, for example, in the container 1 or the sales system 4. The computer system includes a processor as hardware and a memory as main components. The processor executes a program stored in the memory of the computer system, thereby realizing the function as the shopping assistance system 100 of the present disclosure. The program may be stored in the memory of the computer system in advance, provided via telecommunications network, or provided via a non-transitory computer-readable storage medium such as a memory card, an optical disk, a hard disk drive, or the like storing the program. The processor of the computer system includes one or more electronic circuits including a semiconductor integrated circuit (IC) or a large-scale integrated circuit (LSI). The integrated circuit such as IC or LSI mentioned herein may be referred to in another way, depending on the degree of the integration and includes integrated circuits called system LSI, very-large-scale integration (VLSI), or ultra-large-scale integration (ULSI). A field-programmable gate array (FPGA), which is programmable after fabrication of the LSI, or a logical device which allows reconfiguration of connections in LSI or reconfiguration of circuit cells in LSI may be adopted as the processor. The plurality of electronic circuits may be integrated into a single chip or may be distributed on a plurality of chips. The plurality of chips may be collected in one device or may be distributed in a plurality of devices. As mentioned herein, the computer system includes a microcontroller including one or more processors and one or more memories. Thus, the microcontroller is also composed of one or more electronic circuits including a semiconductor integrated circuit or a large-scale integrated circuit.

Collecting the plurality of functions in the shopping assistance system 100 except for the container 1 in one housing is not an essential configuration of the shopping assistance system 100. The components of the shopping assistance system 100 may be distributed in a plurality of housings. Moreover, at least some functions of the shopping assistance system 100 may be realized by, for example, cloud (cloud computing) or the like. In contrast, in the above-described embodiment, at least some of functions of the shopping assistance system 100 distributed in a plurality of device may be collected in one housing.

In the above-described embodiment, the first sensor 221 adopts an optical sensor to sense that an item of goods 8 passes through the specific area (upper opening 11) in the body 10, but the first sensor 221 is not limited to this example. For example, the first sensor 221 may include an ultrasonic sensor in place of the optical sensor and be configured to sense that an item of goods 8 passes through the specific area. In this case, it is only required that the first sensor 221 includes a ultrasonic transmitter in place of the light-emitting element A1 and a ultrasonic receiver in place of the light-receiving element A2.

In the above-described embodiment, the first sensor 221 includes a transmission optical sensor but is not limited to this example. For example, the first sensor 221 may include a reflection optical sensor. In this case, the first sensor 221 senses that an item of goods 8 passes through the specific area by sensing a wave reflected off the item of goods 8. Alternatively, when the ultrasonic sensor is adopted as the first sensor 221 as described above, the ultrasonic sensor may be a transmission ultrasonic sensor or a reflection ultrasonic sensor.

In the above-described embodiment, the second sensor 222 senses acceleration of the body 10 by the acceleration sensor B1 to sense that an item of goods 8 reaches the bottom panel (bottom part) 14 of the body 10, but the second sensor 222 is not limited to this example. For example, the second sensor 222 may adopt a weight sensor in place of the acceleration sensor B1 and be configured to sense that an item of goods 8 reaches the bottom panel (bottom part) 14 of the body 10 when the bottom panel (bottom part) 14 of the body 10 receives weight larger than or equal to a prescribed value.

In the above-described embodiment, the placement sensor 22 senses putting of an item of goods 8 in the body 10 in accordance with the sensed results by both the first sensor 221 and the second sensor 222, but the placement sensor 22 is not limited to this example. For example, the placement sensor 22 may be configured to sense putting of an item of goods 8 in the body 10 in accordance with only one of the sensed result by the first sensor 221 and the sensed result by the second sensor 222.

In the above-described embodiment, the determining processor 23 may be configured to compare the number of information acquired goods and the number of placed goods to determine the placed state (that is, missing acquisition and missing placement) of the goods 8 in the body 10. Specifically, the placement sensor 22 increments the number of times of placement each time the placement sensor 22 senses that an item of goods 8 is put in the body 10. Moreover, each time the receiver 21 acquires goods information on an item of goods 8, the receiver 21 increments the number of times of acquisition. The determining processor 23 monitors the number of times of placement and the number of times of acquisition, for example, at each predetermined time. If the number of times of placement is larger than the number of times of acquisition, the determining processor 23 determines the occurrence of the missing acquisition. If the number of times of acquisition is larger than the number of times of placement, the determining processor 23 determines the occurrence of the missing placement. If the number of times of placement is equal to the number of times of acquisition, the determining processor 23 performs nothing. In consideration of the mean dwell time of customers in the store, the predetermined time is preferably set to a time that the number of times of placement and the number of times of acquisition are monitored at least once while the customer is in the store.

In the above-described embodiment, the determining processor 23 determines both the missing acquisition and the missing placement but may be configured to determine only either the missing acquisition or the missing placement.

In above-described embodiment, the notification appliance 24 notifies a user (customer) of missing acquisition or missing placement each time it occurs, but the notification appliance 24 is not limited to this example. For example, the notification appliance 24 may be configured to notify a user of only a first occurrence of missing acquisition or missing placement and to forgo notifying the user of missing acquisition or missing placement which may occur thereafter. Alternatively, for example, the notification appliance 24 may be configured to notify a user each time missing acquisition or missing placement occurs more than once.

Similarly, in the above-described embodiment, the communication device 25 notifies the sales system 4 each time missing acquisition or missing placement occurs, but the communication device 25 is not limited to this example. For example, the communication device 25 may be configured to notify the sales system 4 of only a first occurrence of missing acquisition or missing placement and to forgo notifying the sales system 4 of missing acquisition or missing placement which may occur thereafter. Alternatively, for example, the communication device 25 may be configured to notify the sales system 4 each time missing acquisition or missing placement occurs more than once.

In the above-described embodiment, a timing at which the notification appliance 24 gives a notification to a user and a timing at which the communication device 25 gives a notification to the sales system 4 may be different form each other.

In the above-described embodiment, the communication device 25 gives a notification to the sales system 4 when the missing acquisition or the missing placement occurs, but the communication device 25 is not limited to this example. For example, the communication device 25 may be configured to give a notification directly to the portable terminal 6 carried by a clerk when the missing acquisition or the missing placement occurs. In this case, the clerk checks the determination information provided to the portable terminal 6, and thus, the clerk can take appropriate measures such as notifying the customer of the occurrence of the missing acquisition or the missing placement, or assisting the customer in the checkout process when the customer performs the checkout process of the goods 8.

In the above-described embodiment, the container 1 includes both the notification appliance 24 and the communication device 25 but may include only any one of them. Alternatively, the container 1 may include neither the notification appliance 24 nor the communication device 25. In this case, for example, when the container 1 is placed in a predetermined location, transmitting the determination information together with the goods information from the transmitter 31 to the sales system 4 enables an appropriate countermeasure to be taken to prevent a wrong checkout process from being executed by the sales system 4.

In the above-described embodiment, when the sales system 4 is notified of the determination information (that is, missing acquisition or missing placement) by the container 1, the sales system 4 performs the weight determining process, but the sales system 4 is not limited to this example. For example, the sales system 4 may be configured to perform the weight determining process before the checkout process of the goods 8 regardless of whether or not the determination information from the container 1 is notified.

In the above-described embodiment, the sales system 4 may be configured not to perform the above-described weight determining process. In this case, when the sales system 4 is notified of the determination information from the container 1, the sales system 4 transmits that the missing acquisition or the missing placement occurs in the container 1 of a specific customer to the portable terminal 6 carried by a clerk. This allows a clerk who checks the determination information by the portable terminal 6 to assist the customer with the checkout process or to perform the checkout process instead of the customer when the specific customer performs the checkout process at the counter desk 7. Alternatively, the sales system 4 may be configured to output a voice notifying the occurrence of the missing acquisition or the missing placement from, for example, the voice output device 47 when the sales system 4 is notified of the determination information from the container 1.

In the above-described embodiment, the sales system 4 performs the weight determining process, but the sales system 4 is not limited to this example. For example, the sales system 4 may be configured to determine whether or not the goods 8 actually put in the body 10 match the targets of the checkout process based on the image determination process using an image recognition technique. Specifically, the sales system 4 captures an image of the goods 8 in the body 10 of the container 1 placed at a predetermined location by an image sensor for capturing an image of the interior of the body 10. The sales system 4 performs an image recognition processing on the image which has been captured to specify the goods 8 actually put in the body 10 so as to determine whether or not the goods 8 actually put in the body 10 match the goods 8 on which respective pieces of goods information are acquired by the receiver 21. In this case, the measuring device 44 of the sales system 4 may be omitted.

Alternatively, the sales system 4 may be configured to determine whether or not the goods 8 actually put in the body 10 matches the targets of the checkout process based on a combination of both the weight determining process and the image determination process. Specifically, the sales system 4 is configured to specify the goods 8 actually put in the body 10 based on the above-described image recognition processing and to acquire, from the checkout system 5, weight data of the goods 8 corresponding to the goods information of the goods 8 which is specified. The sales system 4 is configured to calculate the total weight of the goods put in the body 10 based on the weight data of the goods 8 thus acquired and to compare the total weight of the goods 8 thus calculated with the weight measured by the measuring device 44. In this case, the sales system 4 does not have to acquire the goods information form the container 1.

In the above-described embodiment, the determining processor 23 is configured as a part of the basket controller 37 but may be configured separately from the basket controller 37.

In above-described embodiment, the container 1 is not limited the shopping basket but may be, for example, a shopping carry.

### SUMMARY

As described above, a container (1) according to a first aspect is a container which is portable and which includes a body (10), a receiver (21), a placement sensor (22), and a determining processor (23). The body (10) allows one or more goods (8) to be put in. The placement sensor (22) is provided to the body (10) and is configured to sense that the one or more goods (8) are put in the body (10). The receiver (21) is provided to the body (10) and is configured to acquire respective one or more pieces of goods information on one or more goods (8). The determining processor (23) is provided to the body (10) and is configured to determine a placed state of the one or more goods (8) in the body (10) in accordance with an acquisition result by the receiver (21) and a sensed result by the placement sensor (22).

With this aspect, it is possible to determine whether or not a customer forgets to make the receiver (21) acquire the respective one or more pieces of goods information and/or whether or not a customer forget to put in the body (10) the one or more goods (8) on which the respective one or more pieces of goods information have been acquired by the receiver (21). Here, in order to successfully perform a checkout process of one or more goods (8) to be purchased by a customer, the one or more goods (8) on which the respective one or more pieces of goods information have been acquired by the receiver (21) have to match the one or more goods (8) put in the body (10). That is, as described above, when a customer forgets to make the receiver (21) acquire the respective one or more pieces of goods information of the one or more goods (8) or a customer forgets to put the one or more goods (8) in the body (10), a wrong checkout process may be executed. In the present embodiment, a user (a customer or a clerk) is informed of a determination result by the determining processor (23), and thus, it is possible for a user to know, prior to the checkout process of the one or more goods (8), whether or not the checkout process can be successfully performed. That is, the present embodiment provides the advantage that when a user corrects the placed state of the one or more goods (8) in the body (10) based on the determination result, the one or more goods (8) to be purchased by a customer are less likely to be wrongly checked out.

In a container (1) according to a second aspect referring to the first aspect, the placement sensor (22) includes a first sensor (221) and a second sensor (222). The first sensor (221) is configured to sense that one or more goods (8) pass a specific area (upper opening (11)) in the body (10). The second sensor (222) is configured to sense that one or more goods (8) reach a bottom part (bottom panel) (14) of the body (10).

With this aspect, it is possible to improve the accuracy of sensing that the one or more goods (8) are put in the body (10). That is, by adopting two sensed results, namely, a sensed result by the first sensor (221) and a sensed result by the second sensor (222), it is possible to sense that the one or more goods (8) are put in the body (10) more accurately than by adopting only one sensed result. Specifically, if when only the sensed result by the first sensor (221) is adopted, any object (e.g., a hand of a customer) enters the body (10), the entry of the object may be erroneously sensed as putting in of one item of goods (8). If, when only the sensed result by the second sensor (222) is adopted, a customer hit the body (10) against any object, the hitting may be erroneously sensed as putting in of one item of goods (8). This aspect provides the advantage that the wrong sensing as described above is easily reduced and putting the goods (8) in the body (10) is more accurately sensed.

A container (1) according to a third aspect referring to the first or second aspects, the determining processor (23) is configured to determine, as the placed state of the one or more goods (8) in the body (10), whether or not the placement sensor (22) senses that information acquired goods are put in the body (10). The information acquired goods are the one or more goods (8) on which the respective one or more pieces of goods information have been acquired by the receiver (21).

This aspect provides the advantages that determining whether or not a customer forgets to put the information acquired goods in the body (10) makes it possible to determine a placed state of the one or more goods (8) in the body (10) is a state where the checkout process is to be successfully performed.

In a container (1) according to a fourth aspect referring to the third aspect, the determining processor (23) is configured as described below. That is, the determining processor (23) is configured to determine whether or not the information acquired goods are put in the body (10) based on a corresponding sensed result by the placement sensor (22) within a constant time (T1) from a time point at which the receiver (21) acquires a corresponding piece of goods information.

With this aspect, it is possible to determine whether or not a customer forgets to put the information acquired goods in the body (10) in consideration of a time lag from a time point at which the customer has the receiver (21) acquire goods information of one item of goods (8) to a time point at which the customer puts the one item of goods (8) in the body (10).

In a container (1) according to a fifth aspect referring to any one of the first to fourth aspects, the determining processor (23) is configured to determine, as the placed state of the one or more goods (8) in the body (10), whether or not placed-goods information is acquired by the receiver (21). The placed-goods information is information on placed goods that are the one or more goods (8) having been sensed by the placement sensor (22).

This aspect provides the advantage that determining whether or not a customer forgets to make the receiver (21) acquire the placed-goods information enables determination of whether or not the placed state of the one or more goods (8) in the body (10) is a state allowing a payment process to be successfully performed.

In a container (1) according to a sixth aspect referring to any one of the first to fifth aspects, the determining processor (23) has a configuration as described below. That is, the determining processor (23) is configured to compare the number of the one or more goods (8) on which the respective one or more pieces of goods information have been acquired by the receiver (21) and the number of the one or more goods (8) putting in of which has been sensed by the placement sensor (22) with each other to determine the placed state of the one or more goods (8) in the body (10).

With this configuration, it is possible to determine, in one process, both whether or not a customer forgets to put information acquired goods in the body (10) and whether or not a customer forgets to make the receiver (21) acquire placed-goods information.

A container (1) according to a seventh aspect referring to any one of the first to sixth aspects further includes a notification appliance (24) configured to inform a user of determination information denoting a determination result by the determining processor (23).

This aspect provides the advantage that notifying a user (a customer or a clerk) of the determination information causes the user to become aware that the placed state of the one or more goods (8) in the body (10) is a state where a payment process cannot be successfully performed, thereby easily prompting the user to correct the placed state.

A container (1) according to an eighth aspect referring to any one of the first to seventh aspects further includes a communication device (25) configured to notify a sales system (4) of determination information, the sales system (4) being configured to perform a sales process of one or more goods (8), the determination information denoting a determination result by the determining processor (23).

This aspect provides the advantage that notifying the sales system (4) of the determination information easily causes a countermeasure to correct the placed state to be provided by the sales system (4).

A shopping assistance system (100) according to a ninth aspect includes: the container (1) according to any one of the first to eighth aspects; and a sales system (4) configured to perform a sales process of the one or more goods (8) put in the body (10).

This aspect provides the advantage that the one or more goods (8) to be purchased by a customer are less likely to be wrongly check out.

In a shopping assistance system (100) according to a tenth aspect referring to the ninth aspect, The sales system (4) is configured to execute a process of determining whether or not the one or more goods (8) put in the body (10) match one or more targets of a checkout process.

A shopping assistance method according to an eleventh aspect includes determining a placed state of one or more goods (8) in a body (10) of a container (1) which is portable in accordance with a sensed result of putting of the one or more goods (8) in the body (10) and an acquisition result of respective one or more pieces of goods information on one or more goods (8). The shopping assistance method includes notifying a user of the container (1) of determination information denoting a determination result or notifying a sales system (4) of the determination information. The sales system (4) is configured to perform a sales process of the one or more goods (8) put in the body (10).

This aspect provides the advantage that one or more goods (8) to be purchased by a customer are less likely to be wrongly checked out.

The configurations according to the second to eighth aspects are not essential configurations of the container (1) and may be omitted accordingly.

1. A container being portable and comprising:
a body which allows one or more goods to be put in;
a placement sensor provided to the body and configured to sense that the one or more goods are put in the body;
a receiver provided to the body and configured to acquire respective one or more pieces of goods information on one or more goods; and
a determining processor provided to the body and configured to determine a placed state of the one or more goods in the body in accordance with an acquisition result by the receiver and a sensed result by the placement sensor.

2. The container according to claim 1, wherein
the placement sensor includes:
a first sensor configured to sense that one or more goods pass a specific area in the body; and
a second sensor configured to sense that the one or more goods reach a bottom part of the body.

3. The container according to claim 1, wherein
the determining processor is configured to determine, as the placed state of the one or more goods in the body, whether or not the placement sensor senses that information acquired goods are put in the body, the information acquired goods being the one or more goods on which the respective one or more pieces of goods information have been acquired by the receiver.

4. The container according to claim 3, wherein
the determining processor is configured to determine whether or not the information acquired goods are put in the body based on a corresponding sensed result by the placement sensor within a constant time from a time point at which the receiver acquires a corresponding piece of goods information.

5. The container according to claim 1, wherein
the determining processor is configured to determine, as the placed state of the one or more goods in the body, whether or not placed-goods information is acquired by the receiver, the placed-goods information being information on placed goods that are the one or more goods having been sensed by the placement sensor.

6. The container according to claim 1, wherein
the determining processor is configured to compare a number of the one or more goods on which the respective one or more pieces of goods information have been acquired by the receiver and a number of the one or more goods putting in of which has been sensed by the placement sensor with each other to determine the placed state of the one or more goods in the body.

7. The container according to claim 1, further comprising:
a notification appliance configured to inform a user of determination information denoting a determination result by the determining processor.

8. The container according to claim 1, further comprising:
a communication device configured to notify a sales system of determination information, the sales system being configured to perform a sales process of one or more goods, the determination information denoting a determination result by the determining processor.

9. The container according to claim 2, wherein
the determining processor is configured to determine, as the placed state of the one or more goods in the body, whether or not the placement sensor senses that information acquired goods are put in the body, the information acquired goods being the one or more goods on which the respective one or more pieces of goods information have been acquired by the receiver.

10. The container according to claim 2, wherein
the determining processor is configured to determine, as the placed state of the one or more goods in the body, whether or not placed-goods information is acquired by the receiver, the placed-goods information being information on placed goods that are the one or more goods having been sensed by the placement sensor.

11. The container according to claim 3, wherein
the determining processor is configured to determine, as the placed state of the one or more goods in the body, whether or not placed-goods information is acquired by the receiver, the placed-goods information being information on placed goods that are the one or more goods having been sensed by the placement sensor.

12. The container according to claim 4, wherein
the determining processor is configured to determine, as the placed state of the one or more goods in the body, whether or not placed-goods information is acquired by the receiver, the placed-goods information being information on placed goods that are the one or more goods having been sensed by the placement sensor.

13. The container according to claim 2, wherein
the determining processor is configured to compare a number of the one or more goods on which the respective one or more pieces of goods information have been acquired by the receiver and a number of the one or more goods putting in of which has been sensed by the placement sensor with each other to determine the placed state of the one or more goods in the body.

14. The container according to claim 3, wherein
the determining processor is configured to compare a number of the one or more goods on which the respective one or more pieces of goods information have been acquired by the receiver and a number of the one or more goods putting in of which has been sensed by the placement sensor with each other to determine the placed state of the one or more goods in the body.

15. The container according to claim 4, wherein
the determining processor is configured to compare a number of the one or more goods on which the respective one or more pieces of goods information have been acquired by the receiver and a number of the one or more goods putting in of which has been sensed by the placement sensor with each other to determine the placed state of the one or more goods in the body.

16. The container according to claim 5, wherein
the determining processor is configured to compare a number of the one or more goods on which the respective one or more pieces of goods information have been acquired by the receiver and a number of the one or more goods putting in of which has been sensed by the placement sensor with each other to determine the placed state of the one or more goods in the body.

17. The container according to claim 2, wherein
a notification appliance configured to inform a user of determination information denoting a determination result by the determining processor.

18. A shopping assistance system, comprising:
the container according to claim 1; and
a sales system configured to perform a sales process of the one or more goods put in the body.

19. The shopping assistance system according to claim 18, wherein
the sales system is configured to execute a process of determining whether or not the one or more goods put in the body match one or more targets of a checkout process.

20. A shopping assistance method, comprising:
determining a placed state of one or more goods in a body of a container which is portable in accordance with a sensed result of putting of the one or more goods in the body and an acquisition result of respective one or more pieces of goods information on one or more goods; and
notifying a user of the container of determination information denoting a determination result or notifying a sales system of the determination information, the sales system being configured to perform a sales process of the one or more goods put in the body.
